(19) United States
(12) Patent Application Publication
(10) Pub. No.: US 2015/0324459 A1
(43) Pub. Date: Nov. 12, 2015

(54) METHOD AND APPARATUS TO BUILD A COMMON CLASSIFICATION SYSTEM ACROSS MULTIPLE CONTENT ENTITIES

(71) Applicant: Chegg, Inc., Santa Clara, CA (US)

(72) Inventors: Charmy Chhichhia, San Jose, CA (US); Paul Chris Sri, San Jose, CA (US); Vincent Le Chevalier, San Jose, CA (US)

(73) Assignee: Chegg, Inc., Santa Clara, CA (US)

(21) Appl. No.: 14/274,189

(22) Filed: May 9, 2014

(51) Int. Cl. G06F 17/30; G06N 7/02; G06N 99/00

(52) U.S. Cl. CPC G06F 17/30705; G06N 99/005; G06N 7/02; G06F 17/30011

(57) ABSTRACT

A content classification system classifies documents of a plurality of content entities into a hierarchical discipline structure. The content classification system receives a set of taxonomic labels collectively defining a hierarchical taxonomy and a plurality of documents. Each document is associated with one of the content entities. The content classification system extracts features from the received documents. A learned model is generated for assigning taxonomic labels to documents associated with a representative content entity using the features extracted from documents associated with the representative content entity. The content classification system assigns one or more taxonomic labels to each document of the other content entities using the learned model applied to the features extracted from the respective document. The documents of the plurality of content entities are classified based on the assigned taxonomic labels.

### BACKGROUND

1. Field of the Invention

This disclosure relates to classifying content in a content management system.

2. Description of the Related Art

The successful deployment of electronic textbooks and educational materials by education publishing platforms has introduced multiple alternatives to the traditional print textbook marketplace. By integrating new and compelling digital education services into core academic material, these publishing platforms provide students and instructors with access to a wide range of collaborative tools and solutions that are rapidly changing the way courses are constructed and delivered.

As traditional courses are shifting from a static textbook-centric model to a connected one where related, personalized, and other social-based content activities are being aggregated dynamically within the core academic material, it becomes strategic for education publishing platforms to be able to classify content into a common taxonomy scheme. However, conventional classification techniques are not well suited to classifying a wide variety of content types, as found for example in educational systems. These classification techniques rely upon training and maintenance of separate classifiers for each type of content, resulting in high resource investments and scalability issues.

### SUMMARY

A classification system classifies documents in a content management system. The content management system includes a plurality of content entities, each including a set of documents of a similar type. The classification system extracts features from documents of the plurality of content entities, such as document titles, authors, keywords, and descriptions. The classification system receives a set of taxonomic labels collectively defining a hierarchical taxonomy, and generates a learned model for assigning the taxonomic labels to the documents.

In one embodiment, the classification system classifies the documents of the plurality of content entities using a learned model generated for a representative content entity. A representative content entity is selected based on a feature overlap between the representative content entity and the other content entities in the content management system. The classification system trains the model to assign taxonomic labels to documents of the representative content entity using features extracted from the documents of the representative content entities. To classify documents of the other content entities in the content management system, the classification system applies the learned model to features extracted from the documents to assign taxonomic labels to the documents. By using a model trained for a representative content entity, the classification system classifies a wide variety of disparate content into a single, hierarchical taxonomy.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 illustrates an example education platform, according to one embodiment.

FIG. 2 is a block diagram illustrating interactions with an education platform, according to one embodiment.

FIG. 3 illustrates a document reconstruction process, according to one embodiment.

FIG. 4 illustrates an education publishing platform, according to one embodiment.

FIG. 5 is a block diagram illustrating modules within a content classification system, according to one embodiment.

FIG. 6 is a flowchart illustrating a process for extracting document features, according to one embodiment.

FIG. 7 is a flowchart illustrating a process for analyzing relationships between content entities, according to one embodiment.

FIG. 8 is a flowchart illustrating a process for selecting a representative content entity, according to one embodiment.

FIG. 9 illustrates an example confusion matrix used to determine feature overlap between content entities, according to one embodiment.

FIG. 10 is a flowchart illustrating a process for generating a learned model for assigning taxonomic labels to a representative content entity, according to one embodiment.

FIG. 11 is a flowchart illustrating a process for assigning taxonomic labels to documents using the learned model, according to one embodiment.

FIG. 12 illustrates an example visualization of a hierarchical discipline structure, according to one embodiment.

FIG. 13 illustrates another example visualization of a hierarchical discipline structure, according to one embodiment.

FIG. 14 illustrates yet another example visualization of a hierarchical discipline structure, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Embodiments described herein provide for classification of documents in a content management system. The content management system includes multiple content entities, where each content entity is a set of documents of a similar type. The classification systems and methods described herein enable classification of a variety of disparate content entities into a single, hierarchical taxonomy.

One example content management system managing a wide diversity of documents is an education publishing platform configured for digital content interactive services distribution and consumption. In the platform, personalized learning services are paired with secured distribution and analytics systems for reporting on both connected user activities and effectiveness of deployed services. The education platform manages educational services through the organization, distribution, and analysis of electronic documents.

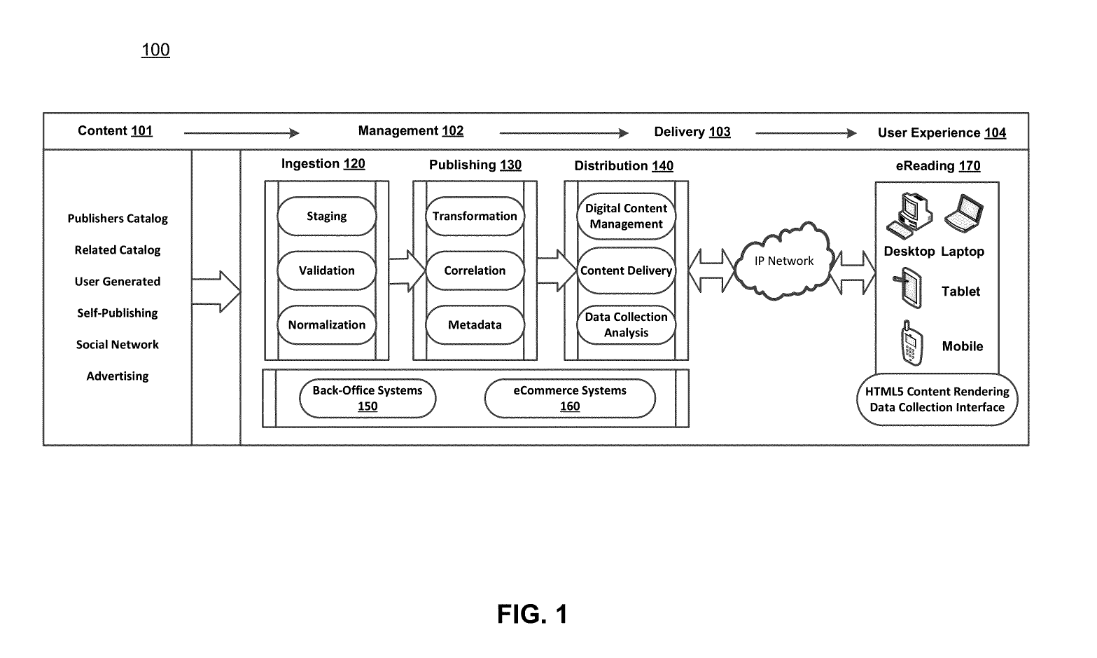

FIG. 1 is a high-level block diagram illustrating the education platform environment 100. The education platform environment 100 is organized around four function blocks: content 101, management 102, delivery 103, and experience 104.

Content block 101 automatically gathers and aggregates content from a large number of sources, categories, and partners. Whether the content is curated, perishable, on-line, or personal, these systems define the interfaces and processes to automatically collect various content sources into a formalized staging environment.

Management block 102 comprises five blocks with respective submodules: ingestion 120, publishing 130, distribution 140, back office system 150, and eCommerce system 160. The ingestion module 120, including staging, validation, and normalization subsystems, ingests published documents that may be in a variety of different formats, such as PDF, ePUB2, ePUB3, SVG, XML, or HTML. The ingested document may be a book (such as a textbook), a set of self-published notes, or any other published document, and may be subdivided in any manner. For example, the document may have a plurality of pages organized into chapters, which could be further divided into one or more sub-chapters. Each page may have text, images, tables, graphs, or other items distributed across the page.

After ingestion, the documents are passed to the publishing system 130, which in one embodiment includes transformation, correlation, and metadata subsystems. If the document ingested by the ingestion module 120 is not in a markup language format, the publishing system 130 automatically identifies, extracts, and indexes all the key elements and composition of the document to reconstruct it into a modern, flexible, and interactive HTML5 format. The ingested documents are converted into markup language documents well-suited for distribution across various computing devices. In one embodiment, the publishing system 130 reconstructs published documents so as to accommodate dynamic add-ons, such as user-generated and related content, while maintaining page fidelity to the original document. The transformed content preserves the original page structure including pagination, number of columns and arrangement of paragraphs, placement and appearance of graphics, titles and captions, and fonts used, regardless of the original format of the source content and complexity of the layout of the original document.

The page structure information is assembled into a document-specific table of contents describing locations of chapter headings and sub-chapter headings within the reconstructed document, as well as locations of content within each heading. During reconstruction, document metadata describing a product description, pricing, and terms (e.g., whether the content is for sale, rent, or subscription, or whether it is accessible for a certain time period or geographic region, etc.) are also added to the reconstructed document.

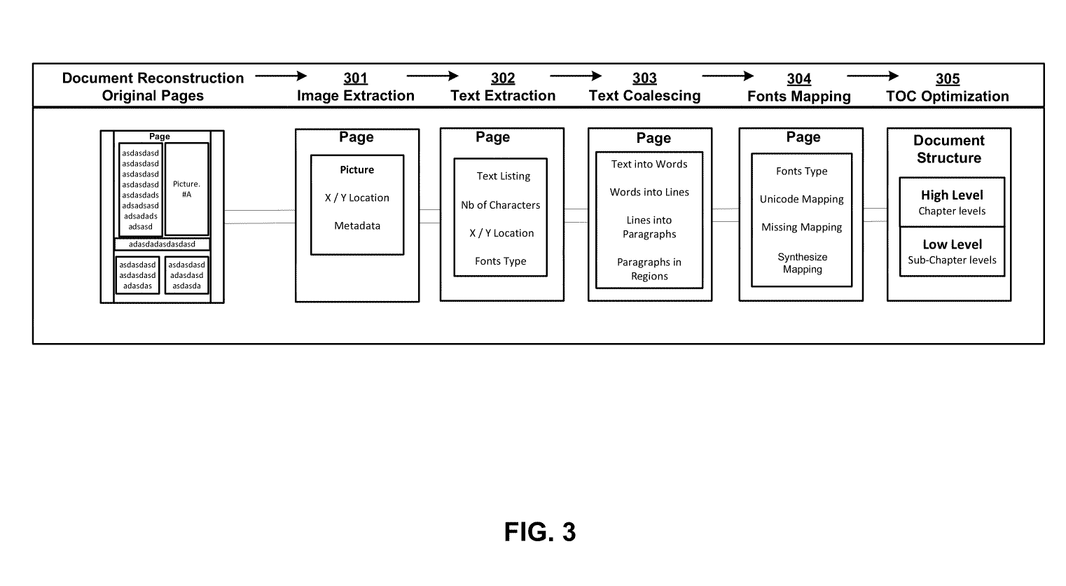

The reconstructed document's table of contents indexes the content of the document into a description of the overall structure of the document, including chapter headings and sub-chapter headings. Within each heading, the table of contents identifies the structure of each page. As content is added dynamically to the reconstructed document, the content is indexed and added to the table of contents to maintain a current representation of the document's structure. The process performed by the publishing system 130 to reconstruct a document and generate a table of contents is described further with respect to FIG. 3.

The distribution system 140 packages content for delivery, uploads the content to content distribution networks, and makes the content available to end users based on the content's digital rights management policies. In one embodiment, the distribution system 140 includes digital content management, content delivery, and data collection and analysis subsystems.

Whether the ingested document is in a markup language document or is reconstructed by the publishing system 130, the distribution system 140 may aggregate additional content layers from numerous sources into the ingested or reconstructed document. These layers, including related content, advertising content, social content, and user-generated content, may be added to the document to create a dynamic, multilayered document. For example, related content may comprise material supplementing the foundation document, such as study guides, textbook solutions, self-testing material, solutions manuals, glossaries, or journal articles. Advertising content may be uploaded by advertisers or advertising agencies to the publishing platform, such that advertising content may be displayed with the document. Social content may be uploaded to the publishing platform by the user or by other nodes (e.g., classmates, teachers, authors, etc.) in the user's social graph. Examples of social content include interactions between users related to the document and content shared by members of the user's social graph. User-generated content includes annotations made by a user during an eReading session, such as highlighting or taking notes. In one embodiment, user-generated content may be self-published by a user and made available to other users as a related content layer associated with a document or as a standalone document.

As layers are added to the document, page information and metadata of the document are referenced by all layers to merge the multilayered document into a single reading experience. The publishing system 130 may also add information describing the supplemental layers to the reconstructed document's table of contents. Because the page-based document ingested into the management block 102 or the reconstructed document generated by the publishing system 130 is referenced by all associated content layers, the ingested or reconstructed document is referred to herein as a “foundation document,” while the “multilayered document” refers to a foundation document and the additional content layers associated with the foundation document.

The back-office system 150 of management block 102 enables business processes such as human resources tasks, sales and marketing, customer and client interactions, and technical support. The eCommerce system 160 interfaces with back office system 150, publishing 130, and distribution 140 to integrate marketing, selling, servicing, and receiving payment for digital products and services.

Delivery block 103 of an educational digital publication and reading platform distributes content for user consumption by, for example, pushing content to edge servers on a content delivery network. Experience block 104 manages user interaction with the publishing platform through browser application 170 by updating content, reporting users' reading and other educational activities to be recorded by the platform, and assessing network performance.

In the example illustrated in FIG. 1, the content distribution and protection system is interfaced directly between the distribution sub-system 140 and the browser application 170, essentially integrating the digital content management (DCM), content delivery network (CDN), delivery modules, and eReading data collection interface for capturing and serving all users' content requests. By having content served dynamically and mostly on-demand, the content distribution and protection system effectively authorizes the download of one page of content at a time through time-sensitive dedicated URLs which only stay valid for a limited time, for example a few minutes in one embodiment, all under control of the platform service provider.

### Platform Content Processing and Distribution

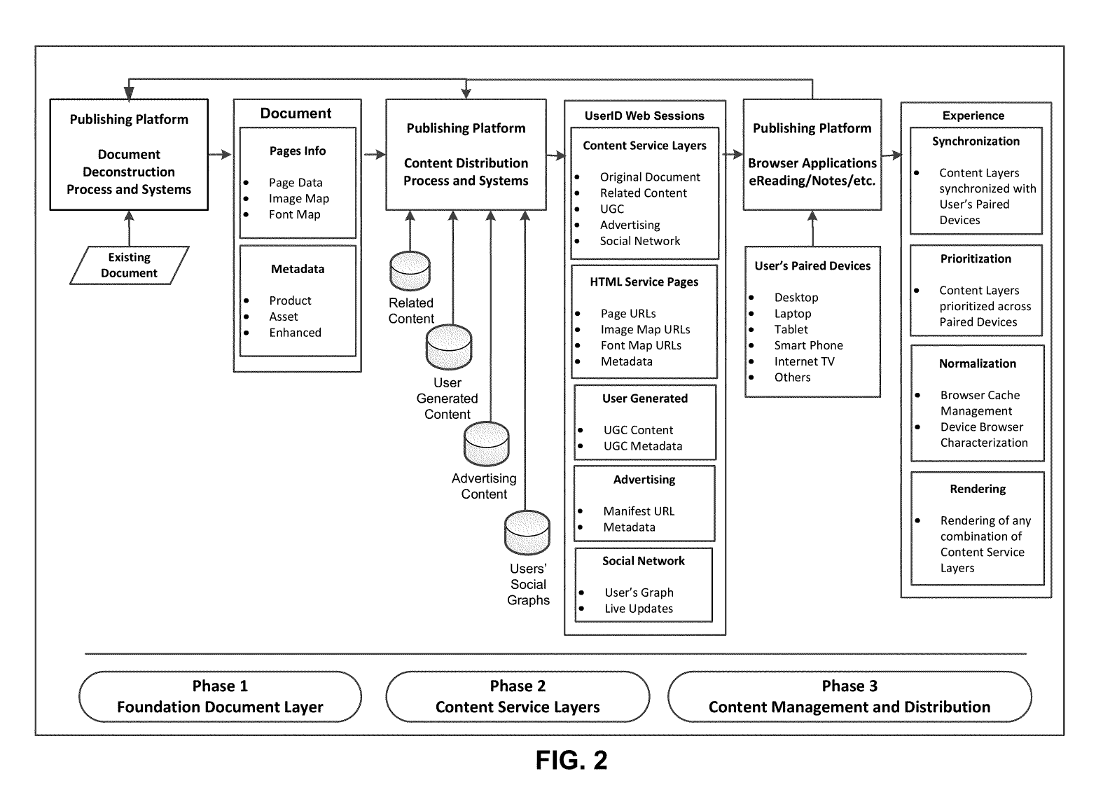

The platform content catalog is a mosaic of multiple content sources which are collectively processed and assembled into the overall content service offering. The content catalog is based upon multilayered publications that are created from reconstructed foundation documents augmented by supplemental content material resulting from users' activities and platform back-end processes. FIG. 2 illustrates an example of a publishing platform where multilayered content document services are assembled and distributed to desktop, mobile, tablet, and other connected devices. As illustrated in FIG. 2, the process is typically segmented into three phases: Phase 1: creation of the foundation document layer; Phase 2: association of the content service layers to the foundation document layer; and Phase 3: management and distribution of the content.

During Phase 1, the licensed document is ingested into the publishing platform and automatically reconstructed into a series of basic elements, while maintaining page fidelity to the original document structure. Document reconstruction will be described in more detail below with reference to FIG. 3.

During Phase 2, once a foundation document has been reconstructed and its various elements extracted, the publishing platform runs several processes to enhance the reconstructed document and transform it into a personalized multilayered content experience. For instance, several distinct processes are run to identify the related content to the reconstructed document, user generated content created by registered users accessing the reconstructed document, advertising or merchandising material that can be identified by the platform and indexed within the foundation document and its layers, and social network content resulting from registered users' activities. By having each of these processes focusing on specific classes of content and databases, the elements referenced within each classes become identified by their respective content layer. Specifically, all the related content page-based elements that are matched with a particular reconstructed document are classified as part of the related content layer. Similarly, all other document enhancement processes, including user generated, advertising and social among others, are classified by their specific content layer. The outcome of Phase 2 is a series of static and dynamic page-based content layers that are logically stacked on top of each other and which collectively enhance the reconstructed foundation document.

During Phase 3, once the various content layers have been identified and processed, the resulting multilayered documents are then published to the platform content catalog and pushed to the content servers and distribution network for distribution. By having multilayered content services served dynamically and on-demand through secured authenticated web sessions, the content distribution systems are effectively authorizing and directing the real-time download of page-based layered content services to a user's connected devices. These devices access the services through time sensitive dedicated URLs which, in one embodiment, only stay valid for a few minutes, all under control of the platform service provider. The browser-based applications are embedded, for example, into HTML5 compliant web browsers which control the fetching, requesting, synchronization, prioritization, normalization and rendering of all available content services.

### Document Reconstruction

The publishing system 130 receives original documents for reconstruction from the ingestion system 120 illustrated in FIG. 1. In one embodiment, a series of modules of the publishing system 130 are configured to perform the document reconstruction process.

FIG. 3 illustrates a process within the publishing system 130 for reconstructing a document. Embodiments are described herein with reference to an original document in the Portable Document Format (PDF) that is ingested into the publishing system 130. However, the format of the original document is not limited to PDF; other unstructured document formats can also be reconstructed into a markup language format by a similar process.

A PDF page contains one or more content streams, which include a sequence of objects, such as path objects, text objects, and external objects. A path object describes vector graphics made up of lines, rectangles, and curves. Path can be stroked or filled with colors and patterns as specified by the operators at the end of the path object. A text object comprises character stings identifying sequences of glyphs to be drawn on the page. The text object also specifies the encodings and fonts for the character strings. An external object XObject defines an outside resource, such as a raster image in JPEG format. An XObject of an image contains image properties and an associated stream of the image data.

During image extraction 301, graphical objects within a page are identified and their respective regions and bounding boxes are determined. For example, a path object in a PDF page may include multiple path construction operators that describe vector graphics made up of lines, rectangles, and curves. Metadata associated with each of the images in the document page is extracted, such as resolutions, positions, and captions of the images. Resolution of an image is often measured by horizontal and vertical pixel counts in the image; higher resolution means more image details. The image extraction process may extract the image in the original resolution as well as other resolutions targeting different eReading devices and applications. For example, a large XVGA image can be extracted and down sampled to QVGA size for a device with QVGA display. The position information of each image may also be determined. The position information of the images can be used to provide page fidelity when rendering the document pages in eReading browser applications, especially for complex documents containing multiple images per page. A caption associated with each image that defines the content of the image may also be extracted by searching for key words, such as “Picture”, “Image”, and “Tables”, from text around the image in the original page. The extracted image metadata for the page may be stored to the overall document metadata and indexed by the page number.

Image extraction 301 may also extract tables, comprising graphics (horizontal and vertical lines), text rows, and/or text columns. The lines forming the tables can be extracted and stored separately from the rows and columns of the text.

The image extraction process may be repeated for all the pages in the ingested document until all images in each page are identified and extracted. At the end of the process, an image map that includes all graphics, images, tables and other graphic elements of the document is generated for the eReading platform.

During text extraction 302, text and embedded fonts are extracted from the original document and the location of the text elements on each page are identified.

Text is extracted from the pages of the original document tagged as having text. The text extraction may be done at the individual character level, together with markers separating words, lines, and paragraphs. The extracted text characters and glyphs are represented by the Unicode character mapping determined for each. The position of each character is identified by its horizontal and vertical locations within a page. For example, if an original page is in A4 standard size, the location of a character on the page can be defined by its X and Y location relative to the A4 page dimensions. In one embodiment, text extraction is performed on a page-by-page basis. Embedded fonts may also be extracted from the original document, which are stored and referenced by client devices for rendering the text content.

The pages in the original document having text are tagged as having text. In one embodiment, all the pages with one or more text objects in the original document are tagged. Alternatively, only the pages without any embedded text are marked.

The output of text extraction 302, therefore, a dataset referenced by the page number, comprising the characters and glyphs in a Unicode character mapping with associated location information and embedded fonts used in the original document.

Text coalescing 303 coalesces the text characters previously extracted. In one embodiment, the extracted text characters are coalesced into words, words into lines, lines into paragraphs, and paragraphs into bounding boxes and regions. These steps leverage the known attributes about extracted text in each page, such as information on the text position within the page, text direction (e.g., left to right, or top to bottom), font type (e.g., Arial or Courier), font style (e.g., bold or italic), expected spacing between characters based on font type and style, and other graphics state parameters of the pages.

In one embodiment, text coalescence into words is performed based on spacing. The spacing between adjacent characters is analyzed and compared to the expected character spacing based on the known text direction, font type, style, and size, as well as other graphics state parameters, such as character-spacing and zoom level. Despite different rendering engines adopted by the browser applications 170, the average spacing between adjacent characters within a word is smaller than the spacing between adjacent words. For example, a string of “Berriesaregood” represents extracted characters without considering spacing information. Once taking the spacing into consideration, the same string becomes “Berries are good,” in which the average character spacing within a word is smaller than the spacing between words.

Additionally or alternatively, extracted text characters may be assembled into words based on semantics. For example, the string of “Berriesaregood” may be input to a semantic analysis tool, which matches the string to dictionary entries or Internet search terms, and outputs the longest match found within the string. The outcome of this process is a semantically meaningful string of “Berries are good.” In one embodiment, the same text is analyzed by both spacing and semantics, so that word grouping results may be verified and enhanced.

Words may be assembled into lines by determining an end point of each line of text. Based on the text direction, the horizontal spacing between words may be computed and averaged. The end point may have word spacing larger than the average spacing between words. For example, in a two-column page, the end of the line of the first column may be identified based on it having a spacing value much larger than the average word spacing within the column. On a single column page, the end of the line may be identified by the space after a word extending to the side of the page or bounding box.

After determining the end point of each line, lines may be assembled into paragraphs. Based on the text direction, the average vertical spacing between consecutive lines can be computed. The end of the paragraph may have a vertical spacing that is larger than the average. Additionally or alternatively, semantic analysis may be applied to relate syntactic structures of phrases and sentences, so that meaningful paragraphs can be formed.

The identified paragraphs may be assembled into bounding boxes or regions. In one embodiment, the paragraphs may be analyzed based on lexical rules associated with the corresponding language of the text. A semantic analyzer may be executed to identify punctuation at the beginning or end of a paragraph. For example, a paragraph may be expected to end with a period. If the end of a paragraph does not have a period, the paragraph may continue either on a next column or a next page. The syntactic structures of the paragraphs may be analyzed to determine the text flow from one paragraph to the next, and may combine two or more paragraphs based on the syntactic structure. If multiple combinations of the paragraphs are possible, reference may be made to an external lexical database, such as WORDNET®, to determine which paragraphs are semantically similar.

In fonts mapping 304, in one embodiment, a Unicode character mapping for each glyph in a document to be reconstructed is determined. The mapping ensures that no two glyphs are mapped to a same Unicode character. To achieve this goal, a set of rules is defined and followed, including applying the Unicode mapping found in the embedded font file; determining the Unicode mapping by looking up postscript character names in a standard table, such as a system TrueType font dictionary; and determining the Unicode mapping by looking for patterns, such as hex codes, postscript name variants, and ligature notations.

For those glyphs or symbols that cannot be mapped by following the above rules, pattern recognition techniques may be applied on the rendered font to identify Unicode characters. If pattern recognition is still unsuccessful, the unrecognized characters may be mapped into the private use area (PUA) of Unicode. In this case, the semantics of the characters are not identified, but the encoding uniqueness is guaranteed. As such, rendering ensures fidelity to the original document.

In table of contents optimization 305, content of the reconstructed document is indexed. In one embodiment, the indexed content is aggregated into a document-specific table of contents that describes the structure of the document at the page level. For example, when converting printed publications into electronic documents with preservation of page fidelity, it may be desirable to keep the digital page numbering consistent with the numbering of the original document pages.

The table of contents may be optimized at different levels of the table. At the primary level, the chapter headings within the original document, such as headings for a preface, chapter numbers, chapter titles, an appendix, and a glossary may be indexed. A chapter heading may be found based on the spacing between chapters. Alternatively, a chapter heading may be found based on the font face, including font type, style, weight, or size. For example, the headings may have a font face that is different from the font face used throughout the rest of the document. After identifying the headings, the number of the page on which each heading is located is retrieved.

At a secondary level, sub-chapter headings within the original document may be identified, such as dedications and acknowledgments, section titles, image captions, and table titles. Vertical spacing between sections, text, and/or font face may be used to segment each chapter. For example, each chapter may be parsed to identify all occurrences of the sub-chapter heading font face, and determine the page number associated with each identified sub-chapter heading.

### Education Publishing Platform

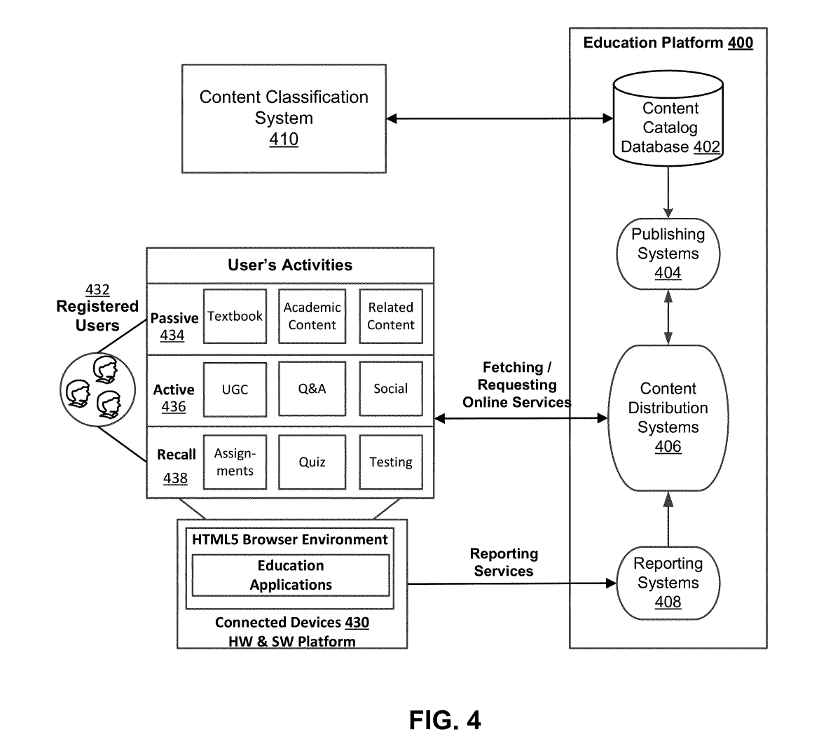

FIG. 4 illustrates an education publishing platform 400, according to one embodiment. The education platform 400 may have components in common with the functional blocks of the platform environment 100, and the HTML5 browser environment 430 may be the same as the eReading application 170 of the experience block 104 of the platform environment 100 or the functionality may be implemented in different systems or modules.

The education platform 400 serves education services to registered users 432 based on a process of requesting and fetching on-line services in the context of authenticated on-line sessions. In the example illustrated in FIG. 4, the education platform 400 includes a content catalog database 402, publishing systems 404, content distribution systems 406, and reporting systems 408. The content catalog database 402 contains the collection of content available via the education platform 402. In one embodiment, the content catalog database 402 includes a number of content entities, such as textbooks, courses, jobs, and videos. The content entities each include a set of documents of a similar type. For example, a textbooks content entity is a set of electronic textbooks or portions of textbooks. A courses content entity is a set of documents describing courses, such as course syllabi. A jobs content entity is a set of documents relating to jobs or job openings, such as descriptions of job openings. A videos content entity is a set of video transcripts. The content catalog database 402 may include numerous other content entities. Furthermore, custom content entities may be defined for a subset of users of the education platform 400, such as sets of documents associated with a particular topic, school, educational course, or professional organization. The documents associated with each content entity may be in a variety of different formats, such as plain text, HTML, JSON, XML, or others.

The content catalog database 402 feeds content to the publishing systems 404. The publishing systems 404 serve the content to registered users 432 via the content distribution system 406. The reporting systems 408 receive reports of user experience and user activities from the connected devices 430 operated by the registered users 432. This feedback is used by the content distribution systems 406 for managing the distribution of the content and for capturing user-generated content and other forms of user activities to add to the content catalog database 402. In one embodiment, the user-generated content is added to a user-generated content entity of the content catalog database 402.

Registered users access the content distributed by the content distribution systems 406 via browser-based education applications executing on a user device 430. As users interact with content via the connected devices 430, the reporting systems 408 receive reports about various types of user activities, broadly categorized as passive activities 434, active activities 436, and recall activities 438. Passive activities 434 include registered users' passive interactions with published academic content materials, such as reading a textbook. These activities are defined as “passive” because they are typically orchestrated by each user around multiple online reading authenticated sessions when accessing the structured HTML referenced documents. By directly handling the fetching and requesting of all HTML course-based document pages for its registered users, the connected education platform analyzes the passive reading activities of registered users.

Activities are defined as “active” when registered users are interacting with academic documents by creating their own user generated content (user-generated content) layer as managed by the platform services. By contrast to “passive” activities, where content is predetermined and static, the process of creating user generated content is unique to each user, both in terms of actual material, format, frequency, or structure, for example. In this instance, user-generated content is defined by the creation of personal notes, highlights, and other comments, or interacting with other registered users 432 through the education platform 400 while accessing the referenced HTML documents. Other types of user-generated content include asking questions when help is needed, solving problems associated with particular sections of course-based HTML documents, and connecting and exchanging feedback with peers, among others. These user-generated content activities are authenticated through on-line “active” sessions that are processed and correlated by the platform content distribution system 406 and reporting system 408.

Recall activities 438 test registered users against knowledge acquired from their passive and active activities. In some cases, recall activities 438 are used by instructors of educational courses for evaluating the registered users in the course, such as through homework assignments, tests, quizzes, and the like. In other cases, users complete recall activities 438 to study information learned from their passive activities, for example by using flashcards, solving problems provided in a textbook or other course materials, or accessing textbook solutions. In contrast to the passive and active sessions, recall activities can be orchestrated around combined predetermined content material with user-generated content. For example, the assignments, quizzes, and other testing materials associated with a course and its curriculum are typically predefined and offered to registered users as structured documents that are enhanced once personal content is added into them. Typically, a set of predetermined questions, aggregated by the platform 400 into digital testing material, is a structured HTML document that is published either as a stand-alone document or as supplemental to a foundation document. By contrast, the individual answers to these questions are expressed as user-generated content in some testing-like activities. When registered users are answering questions as part of a recall activity, the resulting authenticated on-line sessions are processed and correlated by the platform content distribution 406 and reporting systems 408.

A shown in FIG. 4, the education platform 400 is in communication with a content classification system 410. The content classification system 410 classifies content of the education platform 400. The content classification system 410 may be a subsystem of the education platform 400, or may operate independently of the education platform 400. For example, the content classification system 410 may communicate with the education platform 400 over a network, such as the Internet.

The content classification system 410 assigns taxonomic labels to documents in the content catalog database 402 to classify the documents into a hierarchical taxonomy. In particular, the content classification system 410 trains a model for assigning taxonomic labels to a representative content entity, which is a content entity determined to have a high degree of similarity to the other content entities of the catalog database 402. One or more taxonomic labels are assigned to documents of other content entities using the model trained for the representative content entity. Using the assigned labels, the content classification system 410 classifies the documents. Accordingly, the content classification system 410 classifies diverse documents using a single learned model, rather than training a new model for each content entity.

In one embodiment, the content classification system 410 generates a user interface displaying the hierarchical taxonomy to users of the education platform 400. For example, users can use the interface to browse the content of the education platform 400, identifying textbooks, courses, videos, or any other types of content related to subjects of interest to the users. In another embodiment, the content classification system 410 or the education platform 400 recommends content to users based on the classification of the documents. For example, if a user has accessed course documents through the education platform 400, the education platform 400 may recommend textbooks related to the same subject matter as the course to the user.

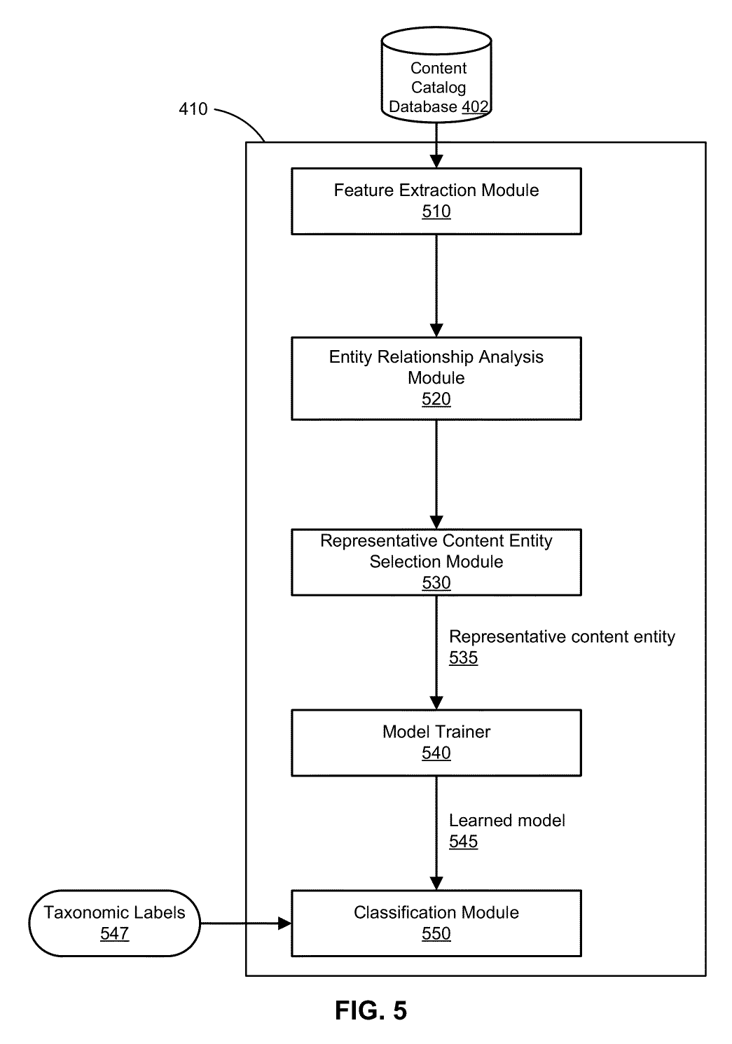

FIG. 5 is a block diagram illustrating modules within the content classification system 410, according to one embodiment. In one embodiment, the content classification system 410 executes a feature extraction module 510, an entity relationship analysis module 520, a representative content entity selection module 530, a model trainer 540, and a classification module 550. Other embodiments of the content classification system 410 may include fewer, additional, or different modules, and the functionality may be distributed differently among the modules.

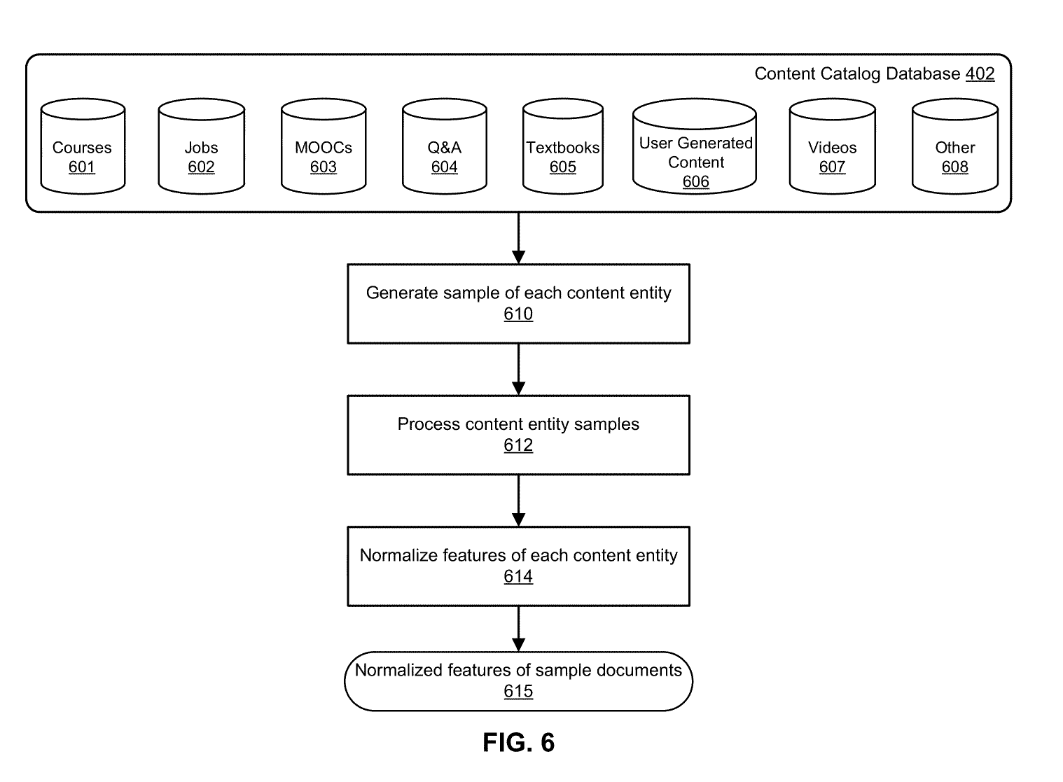

The feature extraction module 510 extracts features from documents in the content catalog database 402. In one embodiment, the feature extraction module 510 analyzes metadata of the documents, such as titles, authors, descriptions, and keywords, to extract features from the documents. A process performed by the feature extraction module 510 to extract features from documents in the content catalog database 402 is described with respect to FIG. 6.

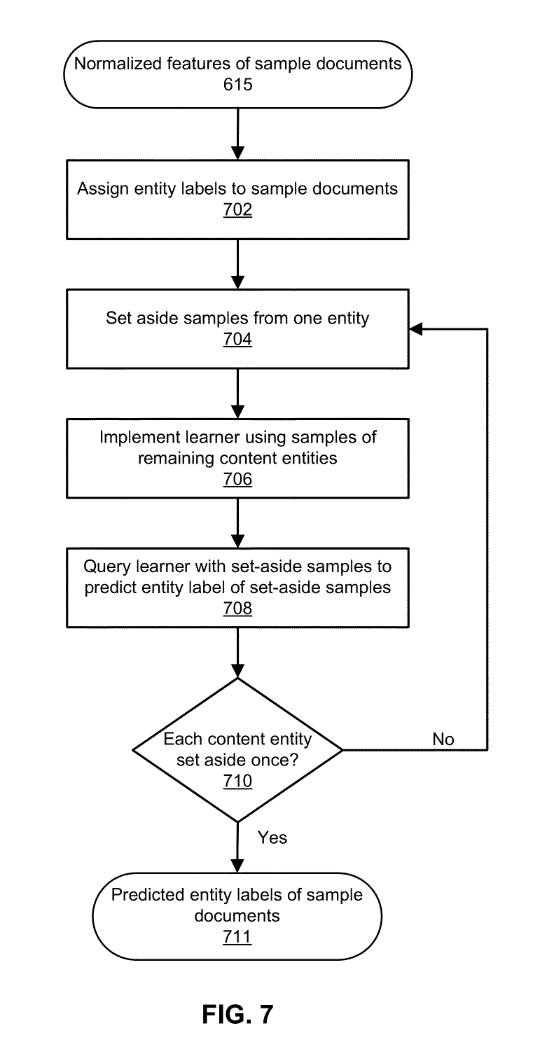

The entity relationship analysis module 520 analyzes relationships between the content entities hosted by the education platform 400. In one embodiment, the entity relationship analysis module 520 determines a similarity between the content entities based on the feature vectors received from the feature extraction module 510. The entity relationship analysis module uses the document features to determine a similarity between each content entity and each of the other content entities. For example, the entity relationship analysis module 520 builds a classifier to classify documents of one content entity into each of the other content entities based on the documents' features. The number of documents of a first content entity classified as a second content entity is indicative of a similarity between the first content entity and the second content entity. An example process performed by the entity relationship analysis module 520 to analyze relationships between content entities is described with respect to FIG. 7.

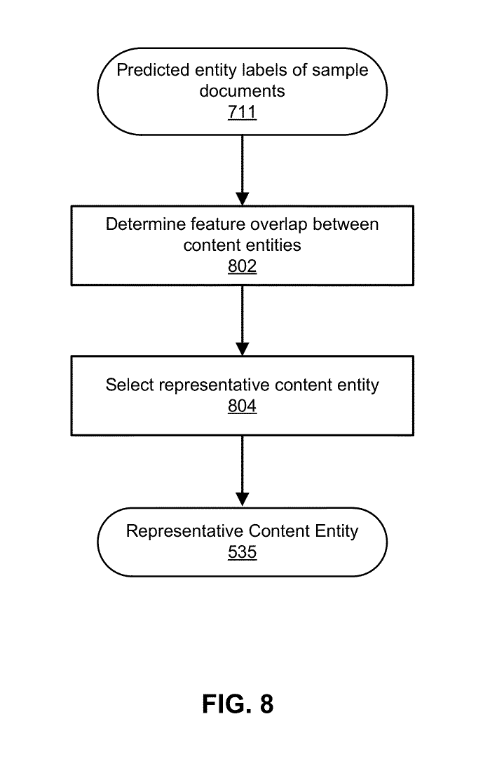

The representative content entity selection module 530 selects one of the content entities hosted by the education platform 400 as a representative content entity 535. In one embodiment, the representative content entity selection module 530 selects a content entity having a high degree of similarity to the other content entities as the representative content entity 535. For example, the representative content entity selection module 530 selects a content entity having a high feature overlap with each of the other content entities, such that the representative content entity 535 is sufficiently representative of the feature space of the other content entities. An example process performed by the representative content entity selection module 530 for selecting the representative content entity is described with respect to FIG. 8.

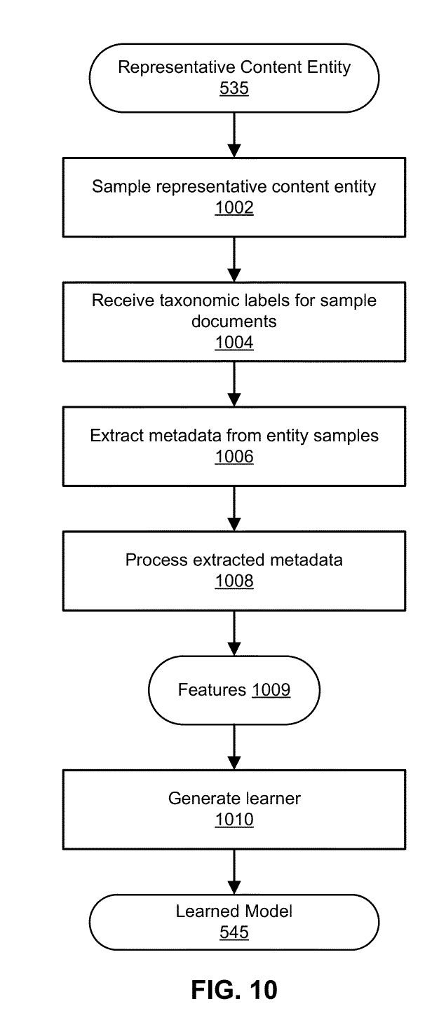

The model trainer 540 trains a model for assigning taxonomic labels to documents of the representative content entity 535. A training set of documents of the representative content entity that have been tagged with taxonomic labels is received. The model trainer 540 extracts features from the training documents and uses the features to train a model 545 for assigning taxonomic labels to an arbitrary document. A process performed by the model trainer 540 for generating the learned model is described with respect to FIG. 10.

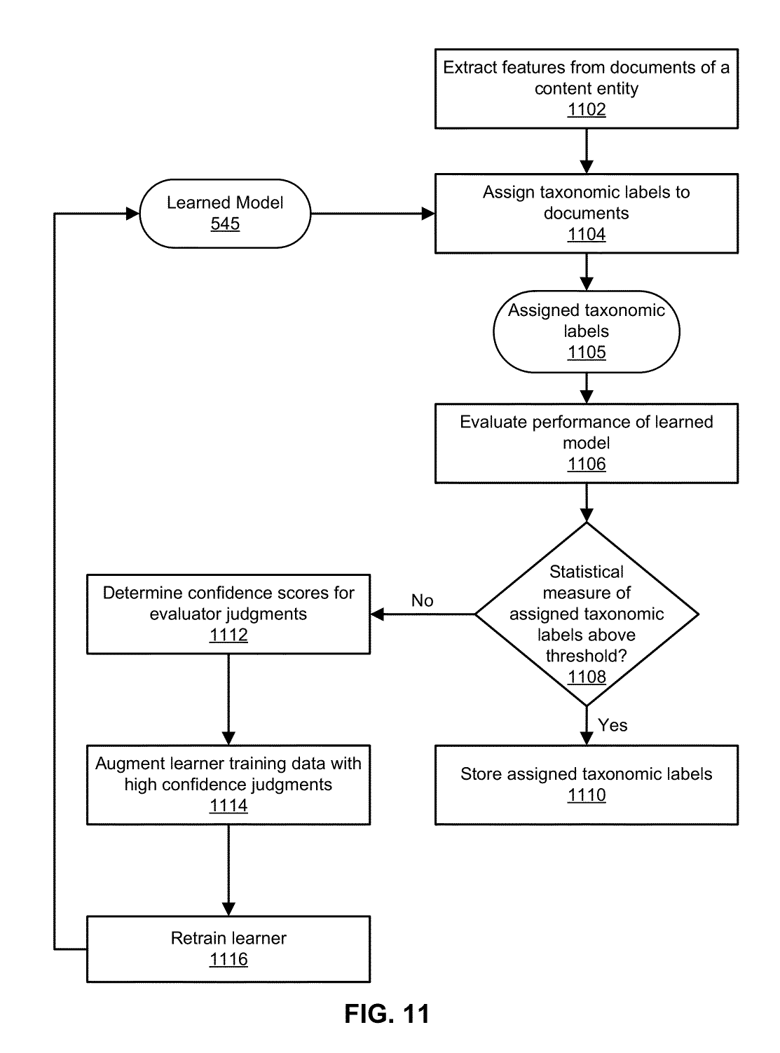

The classification module 550 applies the model 545 trained for the representative content entity to documents of other content entities to classify the documents. The classification module 550 receives a set of taxonomic labels 547, which collectively define a hierarchical taxonomy. A hierarchical taxonomy for educational content includes categories and subjects within each category. For example, art, engineering, history, and philosophy are categories in the educational hierarchical taxonomy, and mechanical engineering, biomedical engineering, computer science, and electrical engineering are subjects within the engineering category. The taxonomic labels 547 may include any number of hierarchical levels. The classification module 550 assigns one or more taxonomic labels to each document of the other content entities using the learned model 545, and classifies the documents based on the applied labels. A process performed by the classification module for assigning taxonomic labels to documents using the learned model 545 is described with respect to FIG. 11.

### Representative Content Entity Selection

FIG. 6 is a flowchart illustrating a process for extracting document features, according to one embodiment. In one embodiment, the process shown in FIG. 6 is performed by the feature extraction module 510 of the content classification system 410. Other embodiments of the process include fewer, additional, or different steps, and may perform the steps in different orders.

As shown in FIG. 6, the content catalog database 402 includes a plurality of content entities. For example, content entities in an education platform include one or more of a courses content entity 601, a jobs content entity 602, a massive online open course (MOOC) content entity, a question and answer content entity 604, a textbooks content entity 605, a user-generated content entity 606, a videos content entity 607, or other content entities 608. The content catalog database 402 may include content entities for any other type of content, including, for example, white papers, study guides, or web pages. Furthermore, there may be any number of content entities in the catalog database 402.

The feature extraction module 510 generates 610 a sample of each content entity in the content catalog database 402. Each sample includes a subset of documents belonging to a content entity. In one embodiment, each sample is a uniform random sample of each content entity.

The feature extraction module 510 processes 612 each sample by a standardized data processing scheme to clean and transform the documents. In particular, the feature extraction module 510 extracts metadata from the documents, including title, author, description, keywords, and the like. The metadata and/or the text of the documents are analyzed by one or more semantic techniques, such as term frequency-inverse document frequency normalization, part-of-speech tagging, lemmatization, latent semantic analysis, or principal component analysis, to generate feature vectors of each sample. As the documents in each content entity may be in a variety of different formats, one embodiment of the feature extraction module 510 includes a pipeline dedicated to each document format for extracting metadata and performing semantic analysis.

After extracting the feature vectors from the content entity samples, the feature extraction module 510 normalizes 614 the features across the content entities. In one embodiment, the feature extraction module 510 weights more representative features in each content entity more heavily than less representative features. The result of normalization 614 is a set of normalized features 615 of the documents in the content entity samples.

FIG. 7 is a flowchart illustrating a method for analyzing relationships between content entities, according to one embodiment. In one embodiment, the process shown in FIG. 7 is performed by the entity relationship analysis module 520 of the content classification system 410. Other embodiments of the process include fewer, additional, or different steps, and may perform the steps in different orders.

The entity relationship analysis module 520 receives the content entity samples and the normalized features 615 extracted from the samples by the feature extraction module 510. The entity relationship analysis module 520 assigns 702 entity labels to the documents according to their respective content entity. For example, textbooks are labeled as belonging to the textbook content entity 605, video transcripts are labeled as belonging to the videos content entity 607, and so forth.

The entity relationship analysis module 520 sets aside 704 samples from one content entity, and implements 706 a learner using samples of the remaining content entities. In one embodiment, the learner implemented by the entity relationship analysis module 520 is an instance-based learner and each document is a training example for the document's content entity. For example, the entity relationship analysis module 520 generates a k-nearest neighbor classifier based on the entity labels of the samples.

The entity relationship analysis module 520 queries 706 the learner with the features of the set-aside samples to predict an entity label for each. For example, if the learner is a k-nearest neighbor classifier, the learner assigns each set-aside sample an entity label based on the similarity between features of the sample and features of the other content entities.

The entity relationship analysis module 520 repeats steps 704 through 708 for each content entity. That is, the entity relationship analysis module 520 determines 710 whether samples of each content entity have been set aside once. If not, the process returns to step 704 and the entity relationship analysis module 520 sets aside samples from another content entity. Once samples from all content entities have been set aside and entity labels predicted for the samples, the entity relationship analysis module 520 outputs the predicted entity labels 711 for each sample document.

FIG. 8 is a flowchart illustrating a process for selecting a representative content entity, according to one embodiment. In one embodiment, the process shown in FIG. 8 is performed by the representative content entity selection module 530 of the content classification system 410. Other embodiments of the process include fewer, additional, or different steps, and may perform the steps in different orders.

The representative content entity selection module 530 uses the predicted entity labels 711 to determine 802 a feature overlap between the content entities in the content catalog database 402. The representative content entity selection module 530 may use one of several frequency-based statistical techniques to determine 802 the feature overlap. One embodiment of the representative content entity selection module 530 determines an overlap coefficient between pairs of the content entities. To determine the overlap coefficient, the representative content entity selection module 530 builds a density plot of the predicted labels assigned to each sample document in the pair and determines an overlapping area under the curves. In another embodiment, the representative content entity selection module 530 determines a Kullback-Leibler (KL) divergence between pairs of the content entities.

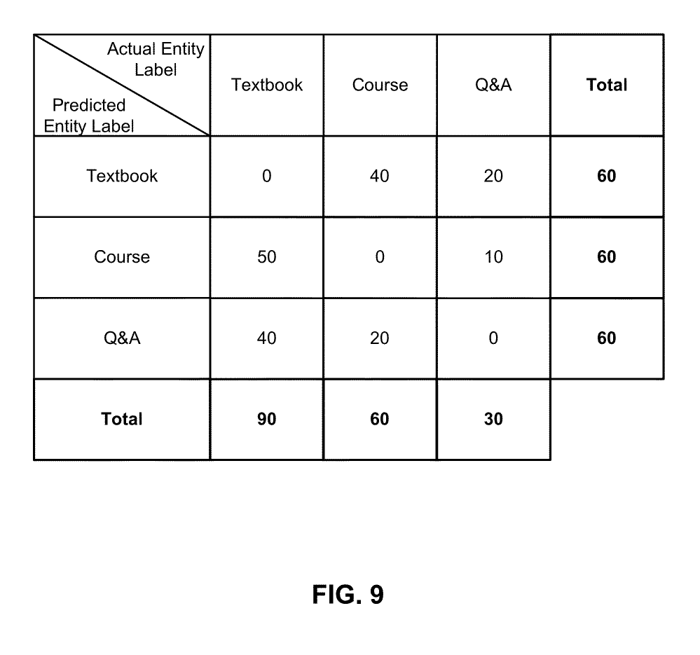

Yet another embodiment of the representative content entity selection module 530 uses a confusion matrix to determine 802 the feature overlap between content entities. An example confusion matrix between a textbook content entity, a courses content entity, and a question and answer content entity is illustrated in FIG. 9. In the example of FIG. 9, 60 documents from each content entity were analyzed by the process shown in FIG. 7 to predict entity labels of the documents. Out of the 60 textbooks, 40 were labeled as courses and 20 were labeled as Q&A. Out of the 60 course documents, 50 were predicted to belong to the textbooks content entity and 10 were predicted to belong to the Q&A content entity. Lastly, out of the 60 Q&A documents, 40 were predicted to belong to the textbooks content entity and 20 were predicted to belong to the courses content entity. Thus, a total of 90 sample documents were predicted to be textbooks, 60 were predicted to be courses, and 30 were predicted to be Q&A.

Based on the determined feature overlap, the representative content entity selection module 530 selects 804 the representative content entity 535. In one embodiment, the representative content entity 535 is a content entity having a high feature overlap with each of the other content entities. For example, if the representative content entity selection module 530 determines an overlap coefficient between pairs of the content entities, the representative content entity selection module 530 selects the content entity having a high overlap coefficient with each of the other content entities as the representative content entity. If the representative content entity selection module 530 used a KL divergence to determine the feature overlap between entities, the content entity having a small divergence from each of the other content entities is selected as the representative content entity. Finally, if the representative content entity selection module 530 used a confusion matrix to determine the feature overlap, the content entity with a high column summation in the confusion matrix is selected as the representative content entity. Thus, in the example of FIG. 9, the textbook content entity may be selected as the representative content entity because the textbook column summation is higher than the columns of the other content entities. A high feature overlap between the representative content entity and the other content entities indicates that a majority of features of the other content entities are similar to features of the representative content entity. Likewise, few features of the other content entities are dissimilar to at least one feature of the representative content entities. Accordingly, a high feature overlap indicates that the representative content entity largely spans the feature space covered by the content entities of the content catalog database 402.

### Classifying Documents

The content classification system 410 uses features of the representative content entity 535 to generate a learned model. FIG. 10 is a flowchart illustrating a process for generating the learned model for the representative content entity, according to one embodiment. In one embodiment, the process shown in FIG. 10 is performed by the model trainer 540 of the content classification system 410. Other embodiments of the process include fewer, additional, or different steps, and may perform the steps in different orders.

The model trainer 540 samples 1002 the representative content entity 535 to select a set of documents for a training set. In one embodiment, the sample generated by the model trainer 540 is a uniform random sample of the representative content entity 535.

The model trainer 540 receives 1004 taxonomic labels for the sample documents. In one embodiment, the taxonomic labels are applied to the sample documents by subject matter experts, who evaluate the sample documents and assign one or more taxonomic labels to each document to indicate subject matter of the document. For example, the subject matter experts may assign a category label and a subject label to each sample document.

Another embodiment of the model trainer 540 receives a set of documents of the representative content entity 535 that have been tagged with taxonomic labels, and uses the received documents as samples of the representative content entity.

The model trainer 540 extracts 1006 metadata from the entity samples, such as title, author, description, and keywords. The model trainer 540 processes 1008 the extracted metadata to generate a set of features 1009 for each sample documents. In one embodiment, the model trainer 540 processes 1008 the extracted metadata by one or more semantic analysis techniques, such as n-gram models, term frequency-inverse document frequency, part-of-speech tagging, custom stopword removal, custom synonym analysis, lemmatization, latent semantic analysis, or principal component analysis.

The model trainer 540 uses the extracted features 1009 to generate 1010 a learner for applying taxonomic labels to documents of the representative content entity. The model trainer 540 receives the taxonomic labels applied to the sample documents and the features 1009 of the sample documents, and generates the model. In one embodiment, the model trainer 540 generates the model using an ensemble method, such as linear support vector classification, logistic regression, k-nearest neighbor, naïve Bayes, or stochastic gradient descent. The model trainer 540 outputs the learned model 545 to the classification module 550 for classifying documents of the other content entities.

FIG. 11 is a flowchart illustrating a method for assigning taxonomic labels to documents using the learned model 545, according to one embodiment. In one embodiment, the process shown in FIG. 11 is performed by the classification module 550 of the content classification system 410. The classification module 550 performs the process shown in FIG. 11 for each content entity of the content catalog database 402. Other embodiments of the process include fewer, additional, or different steps, and may perform the steps in different orders.

The classification module 550 extracts 402 features from documents of a content entity in the content catalog database 402. To extract 402 the features, the classification module 550 may perform similar techniques as the model trainer 540, including metadata extraction and semantic analysis.

The classification module 550 applies the learned model 545 to the extracted features to assign 1104 taxonomic labels to the documents, generating a set of assigned taxonomic labels 1105 for each document in the content entity under evaluation. In one embodiment, the classification module 540 applies at least a category label and a subject label to each document, though labels for additional levels in the taxonomic hierarchy may also be applied to the documents. Moreover, multiple category and subject labels may be assigned to a single document.

The classification module 550 evaluates 1106 the performance of the learned model 545 in applying taxonomic labels to the documents of the content entity under evaluation. In one embodiment, the classification module 550 receives human judgments of appropriate taxonomic labels to be applied to a subset of the documents of the evaluated content entity (e.g., a random sample of the evaluated content entity's documents). The classification module 550 generates a user interface for display to the evaluators that provides a validation task for each of a subset of documents. Example validation tasks include approving or rejecting the labels assigned by the learned model 545 or rating the labels on a scale (e.g., on a scale from one to five). Other validation tasks requests evaluators to manually select taxonomic labels to be applied to the documents of the subset, for example by entering free-form text or selecting the labels from a list. Based on the validation tasks performed by the evaluators, the classification module 550 generates one or more statistical measures of the performance of the learned model 545. These statistical measures may include, for example, an Fl score, area under the receiver operator curve, precision, sensitivity, accuracy, or negative prediction value.

The classification module 550 determines 1108 whether the statistical measures of the model's performance are above corresponding thresholds. If so, the classification module 550 stores 110 the taxonomic labels assigned to the documents of the evaluated content entity by the learned model 545. The classification module 550 may then repeat the process shown in FIG. 11 for another content entity, if any content entities remain to be evaluated.

If the performance of the learned model 545 does not meet statistical thresholds, the classification module 550 determines 1112 confidence scores for the evaluator judgments. For example, the classification module 550 scores each judgment based on a number of judgments per document, a number of evaluators who agreed on the same judgment, a quality rating of each evaluator, or other factors.

The classification module 550 uses the evaluator judgments to augment 1114 the training data for the learned model 545. The classification module 550 selects evaluator judgments having a high confidence score and adds the corresponding documents and assigned taxonomic labels to the training set for the learned model 545. The classification module 550 retrains 1116 the learned model 545 using the augmented training set. The retrained model is applied to the features extracted from documents of the content entity under evaluation to assign 1104 taxonomic labels to the documents.

The process shown in FIG. 11 is repeated until taxonomic labels are stored for documents of each of the content entities in the content catalog database 402. Similarly, when a new content entity is added to the catalog database 402, the classification module 550 assigns taxonomic labels to the documents of the new content entity by the process shown in FIG. 11. Accordingly, the classification module 550 classifies the documents of the new content entity using the model trained for the representative content entity, rather than training a new model for the entity.

By assigning taxonomic labels to documents of multiple content entities, the content classification system 410 provides a classification of the documents. When classifying educational documents, for example, the content classification system 410 classifies the documents into a hierarchical discipline structure of content categories and subjects within each category based on the taxonomic labels assigned to the documents.

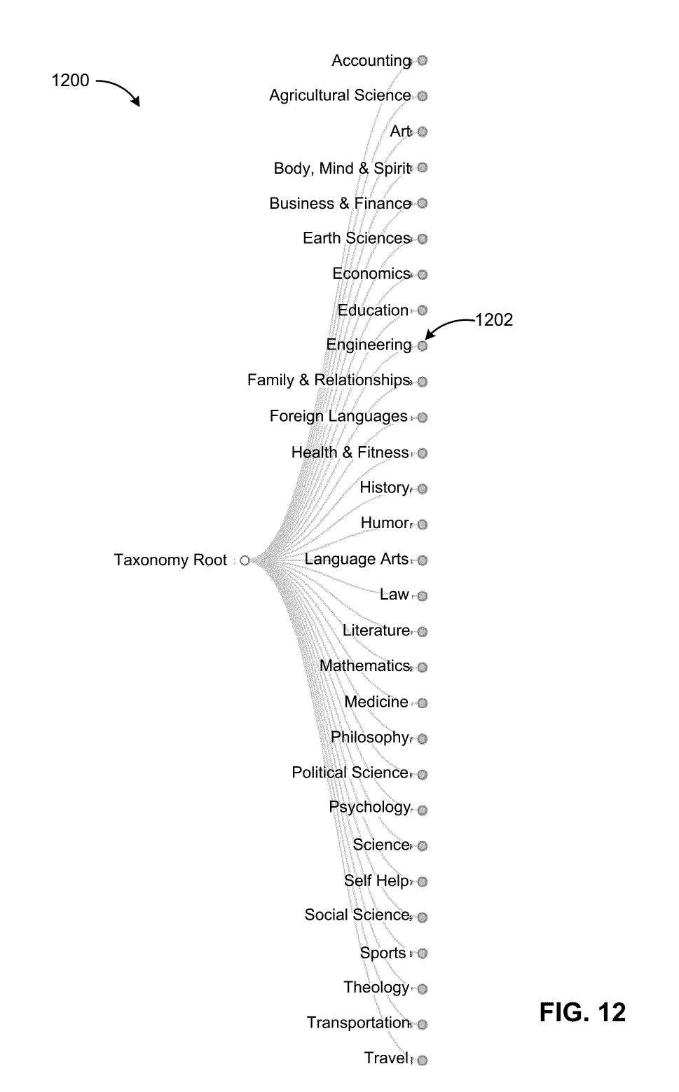

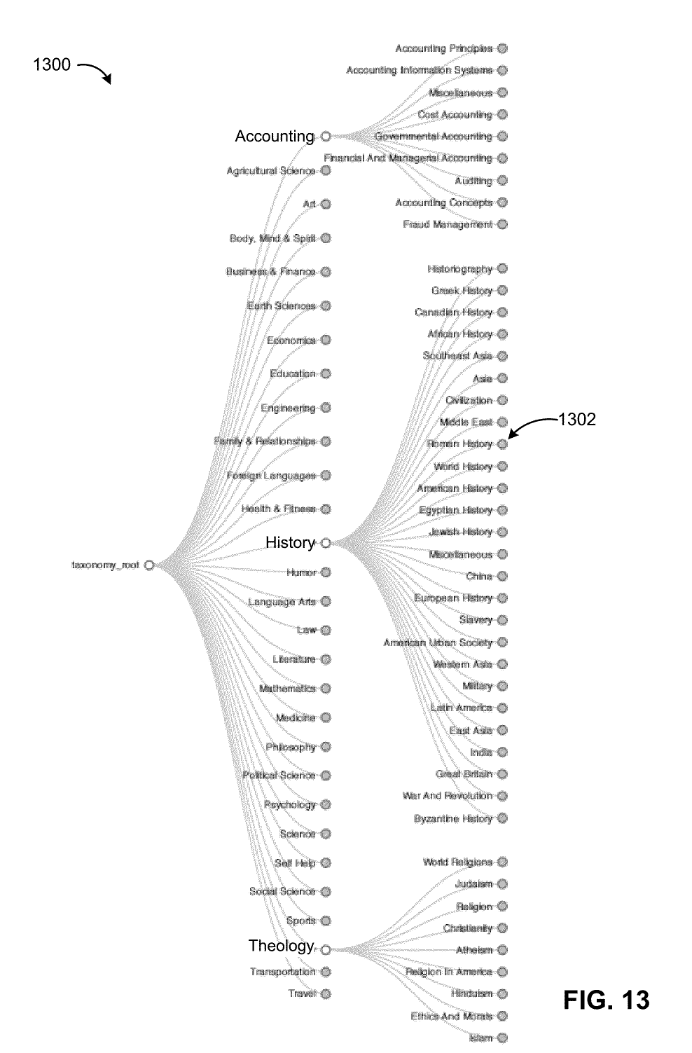

FIGS. 12-14 illustrate example visualizations of the hierarchical discipline structure generated by the content classification system 410. The example visualizations may be displayed to a user of the education platform 400. For example, a user interacts with the visualizations to browse content of the education platform 400. FIG. 12 illustrates a first level 1200 of the hierarchy, including a number of content categories 1202. FIG. 13 illustrates an example visualization 1300 in which three categories of the visualization 1200 have been expanded to display a number of subjects 1302 within the categories. For example, a user can expand each of the categories in the visualization 1200 to view subjects within the category in the taxonomic hierarchy.

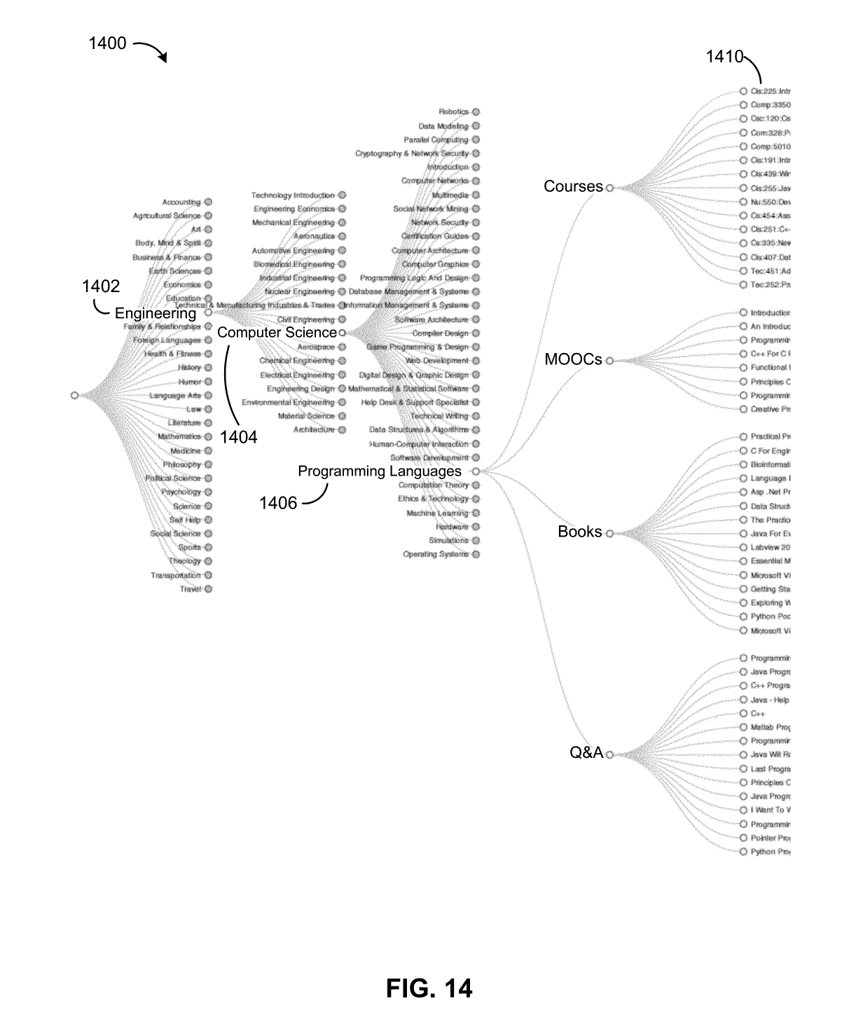

FIG. 14 illustrates an example visualization 1400 of documents 1410 classified into a three-tier taxonomic hierarchy. Each of the documents in the example of FIG. 14 has been labeled with an “engineering” category label 1402, a “computer science” subject label 1404, and a “programming languages” sub-subject label 1406. Using the visualization 1400 shown in FIG. 14, the user can browse documents in the selected category, subject, and sub-subject, whether the documents belong to a courses content entity, a MOOCs content entity, a books content entity, or a question and answer content entity. Other content entities may also be included in the visualization 1400. Furthermore, the hierarchical discipline structure may include fewer or additional levels than a category, subject, and sub-subject.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML or HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for classifying documents of a plurality of content entities into a hierarchical discipline structure in a content management system, the method comprising:
accessing a set of taxonomic labels, the taxonomic labels collectively defining a hierarchical taxonomy;
receiving a plurality of documents, each document associated with one of the content entities;
extracting features of the received documents;
generating by a content classification system, a learned model for assigning taxonomic labels to documents associated with a representative content entity using the features extracted from documents associated with the representative content entity;
assigning, by the content classification system, one or more taxonomic labels to each document of the other content entities using the learned model applied to the features extracted from the respective document; and
classifying the documents of the plurality of content entities based on the assigned taxonomic labels.

2. The method of claim 1, further comprising:
recommending a document to a user based on the classification of the documents.

3. The method of claim 1, further comprising:
for each of the plurality of content entities, determining a feature overlap between features extracted from documents associated with the content entity and features extracted from documents associated with the other content entities; and
selecting the representative content entity responsive to the documents associated with the representative content entity having a high feature overlap with documents associated with the other content entities.

4. The method of claim 3, wherein determining the feature overlap comprises:
predicting for each of a plurality of documents, a content entity associated with the document; and
for a document associated with a first content entity, responsive to predicting the document as being associated with a second content entity, identifying a feature overlap between the first content entity and the second content entity.

5. The method of claim 1, further comprising:
for one of the content entities, receiving judgments from evaluators of the taxonomic labels assigned to a subset of the documents associated with the content entity; and
modifying the learned model based on the received evaluator judgments.

6. The method of claim 5, further comprising:
determining a confidence score for each evaluator judgment;
wherein modifying the learned model based on the received evaluator judgments comprises retraining the learned model using evaluator judgments with confidence scores above a threshold.

7. The method of claim 1, wherein the set of taxonomic labels includes labels for each of a plurality of categories and a plurality of subjects within each category, and wherein assigning the one or more taxonomic labels to each document comprises assigning a category label and a subject label to each document.

8. The method of claim 1, wherein the plurality of content entities include at least two selected from the group consisting of textbooks, jobs, academic courses, sets of questions and answers, and academic video transcriptions.

9. The method of claim 1, wherein the features extracted from each received document include at least one selected from the group consisting of a title of the document, an author of the document, keywords of the document, and a description of the document.

10. The method of claim 1, further comprising:
receiving a plurality of documents associated with a new content entity;
assigning, by the content classification system, one or more taxonomic labels to each document of the new content entity using the learned model applied to the features extracted from the respective document; and
classifying the documents associated with the new content entity based on the assigned taxonomic labels.

11. The method of claim 1, further comprising:
generating a user interface for display to a user, the user interface including a representation of a hierarchy of the taxonomic labels and a plurality of the documents associated with each of the taxonomic labels in the hierarchy.

12. A non-transitory computer readable storage medium storing computer program instructions for classifying documents of a plurality of content entities into a hierarchical discipline structure, the computer program instructions when executed by a processor causing the processor to:
access a set of taxonomic labels, the taxonomic labels collectively defining a hierarchical taxonomy;
receive a plurality of documents, each document associated with one of the content entities;
extract features of the received documents;
generate a learned model for assigning taxonomic labels to documents associated with a representative content entity using the features extracted from documents associated with the representative content entity;
assign one or more taxonomic labels to each document of the other content entities using the learned model applied to the features extracted from the respective document; and
classify the documents of the plurality of content entities based on the assigned taxonomic labels.

13. The non-transitory computer readable storage medium of claim 12, further comprising computer program instructions that when executed by a processor cause the processor to:
recommend a document to a user based on the classification of the documents.

14. The non-transitory computer readable storage medium of claim 12, further comprising computer program instructions that when executed by a processor cause the processor to:
for each of the plurality of content entities, determine a feature overlap between features extracted from documents associated with the content entity and features extracted from documents associated with the other content entities; and
select the representative content entity responsive to the documents associated with the representative content entity having a high feature overlap with documents associated with the other content entities.

15. The non-transitory computer readable storage medium of claim 14, wherein the computer program instructions causing the processor to determine the feature overlap further cause the processor to:
predicting for each of a plurality of documents, a content entity associated with the document; and
for a document associated with a first content entity, responsive to predicting the document as being associated with a second content entity, identifying a feature overlap between the first content entity and the second content entity.

16. The non-transitory computer readable storage medium of claim 12, further comprising computer program instructions that when executed by a processor cause the processor to:
for one of the content entities, receive judgments from evaluators of the taxonomic labels assigned to a subset of the documents associated with the content entity; and
modify the learned model based on the received evaluator judgments.

17. The non-transitory computer readable storage medium of claim 16, further comprising computer program instructions that when executed by a processor cause the processor to:
determine a confidence score for each evaluator judgment;
wherein the computer program instructions causing the processor to modify the learned model based on the received evaluator judgments further cause the processor to retrain the learned model using evaluator judgments with confidence scores above a threshold.

18. The non-transitory computer readable storage medium of claim 12, wherein the set of taxonomic labels includes labels for each of a plurality of categories and a plurality of subjects within each category, and wherein the computer program instructions causing the processor to assign the one or more taxonomic labels to each document further cause the processor to assign a category label and a subject label to each document.

19. The non-transitory computer readable storage medium of claim 12, wherein the plurality of content entities include at least two selected from the group consisting of textbooks, jobs, academic courses, sets of questions and answers, and academic video transcriptions.

20. The non-transitory computer readable storage medium of claim 12, wherein the features extracted from each received document include at least one selected from the group consisting of a title of the document, an author of the document, keywords of the document, and a description of the document.
